(19) United States
(12) Patent Application Publication
(10) Pub. No.: US 2026/0010895 A1
(43) Pub. Date: Jan. 8, 2026

(54) WRAPPED TOKEN FOR PROVIDING TOKENIZED LINE OF CREDIT

(71) Applicant: AMERICAN EXPRESS TRAVEL RELATED SERVICES COMPANY, INC., New York, NY (US)

(72) Inventor: Lucky A. BIMOLAKSONO, Sydney (AU)

(73) Assignee: AMERICAN EXPRESS TRAVEL RELATED SERVICES COMPANY, INC., New York, NY (US)

(21) Appl. No.: 18/762,135

(22) Filed: Jul. 2, 2024

(51) Int. Cl. G06Q 20/36; G06Q 20/10

(52) U.S. Cl. CPC G06Q 20/367; G06Q 20/10

(57) ABSTRACT

Disclosed herein are system, method, and computer program product embodiments for tokenization of a line of credit. A method include generating, using at least one processor of an issuer system, a token that represents a line of credit value for a customer account. The method further comprises attaching a smart contract to the token to generate a wrapped token. The smart contract is configured to implement one or more rules associated with the customer account. The method further comprises detecting a trigger event associated with a change in a balance of the line of credit value or the one or more rules and in response to detecting the trigger event, syncing in real-time the wrapped token to the balance of the line of credit value.

### TECHNICAL FIELD

Aspects relate to systems and methods for generating a specially formatted token that represents a line of credit for an improved method for performing a digital transaction with a credit card-like payment.

### BACKGROUND

Digital assets (e.g., digital currency) can be used as an alternative form of currency for exchanging goods and services. A customer may desire to extend an available line of credit offered by the financial institution to digital assets or when transacting on a blockchain platform. For example, the customer may have a line of credit for a payment card in a fiat currency (e.g., United States Dollar) but would like to have the line of credit available when transacting on the blockchain platform. However, a technical challenge relates to maintaining a balance of the line of credit in real time and being able to utilize that line of credit as part of a digital transaction.

### SUMMARY

Disclosed herein are system, apparatus, device, method and/or computer program product embodiments, and/or combinations and sub-combinations thereof, for generating a digital token that represents a line of credit for an improved method for performing a digital transaction with a credit card-like payment.

In some embodiments, a method may include generating, using at least one processor of an issuer system, a digital token that represents a line of credit value for a customer account for performing a digital transaction with a credit card-like payment. The method further comprises attaching a smart contract to the token. The smart contract is configured to implement payment criteria, such as one or more rules (e.g., fraud, anti-money laundering (AML)), benefits, incentives, associated with the customer account. The method further comprises detecting a trigger event associated with a change in a balance of the line of credit value or the one or more rules and in response to detecting the trigger event, syncing in real-time the smart contract wrapped token with the line of credit.

In some embodiments, a system comprises a memory and at least one processor coupled to the memory. The at least one processor is configured to generate a token that represents a line of credit value for a customer account, attach a smart contract to the token, detect a trigger event associated with a change in a balance of the line of credit value or the one or more rules, and in response to detecting the trigger event, sync in real-time the smart contract wrapped token with the line of credit. In some embodiments, one or more rules of the smart contract wrapped token may be updated. The digital token may then be used similar to a traditional credit card payment, such as a merchant payment (i.e., from a customer digital wallet to a merchant digital wallet, such as an online transaction) or a customer payment (i.e., from the merchant digital wallet to the customer digital wallet, such as rewards or points redemption).

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for an issuing system, in accordance with an embodiment of the present disclosure.

FIG. 2 is a schematic that illustrates a token generation flow, in accordance with an embodiment of the present disclosure.

FIG. 3 is a schematic that illustrates a transaction flow, in accordance with an embodiment of the present disclosure.

FIG. 4 is a schematic that illustrates a token redemption flow, in accordance with an embodiment of the present disclosure.

FIG. 5 is an example method for generating a token, in accordance with an embodiment of the present disclosure

FIG. 6 is an example method for performing a transaction, in accordance with an embodiment of the present disclosure.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

Aspects of the present disclosure relate to systems and methods for generating a digital token that represents a line of credit. In particular, the present disclosure relates to generating the token that represents the line of credit synced in real-time and formatting (e.g., wrapping the token with account criteria) the token in a manner so that it can be used as part of a payment transaction.

As described in the background, a customer may desire to extend an available line of credit offered by a financial institution for use in transactions involving blockchain technology (e.g., decentralized finance) or performing an online transaction between different entities (e.g., from a customer account to a merchant account, or from the merchant account to the customer account). However, a technical challenge relates to maintaining an accurate balance of the line of credit because some of the transactions are performed in traditional finance (TradFi) and some transactions may be performed in decentralized finance (DeFi). Provided herein is a system configured to syncing in real time a token that represent a line of credit associated with an account and formatting the token with a wrapper to enable the digital token as a replacement for a traditional credit card payment. When appropriately formatted, the tokenized line of credit may be deployed for digital transactions, such as those involving a digital asset (e.g., cryptocurrencies) or with systems and networks associated with DeFi (e.g., customer account to merchant account payments, merchant account to customer account payments). The system may also synchronize the line of credit of a corresponding account in real time for transactions that involve non-digital assets (e.g., fiat currency) using traditional finance. Whereas previously, a user may not use an available line of credit for transaction involving DeFi, aspects of the present disclose improve upon prior art systems by creating a digital token that represents the line of credit that is synchronized in real time and formatted in a manner such that the token may be utilized as payment within a payment network.

The present disclose provides an improvement in the technologies of electronic devices and mobile payments by providing a tokenization process that represents the line of credit to generate a digital token that is constructed so that the token may be utilized as payment between digital accounts. In addition, fraud and unauthorized transactions are minimized by generating a smart contract and formatting a token via a wrapped smart contract. Via the formatted token, the smart contract, via payment criteria such as payment rules, benefits, and incentives, is used to automatically monitor the implementations of one or more rules associated with the account associated with the line of credit and/or transactions. The use of the smart contract wrapped token further addresses issues with respect to transparency and auditability. The smart contract wrapped token improves cyber security. In addition, because the wrapper is generated by a financial institution, the smart contract wrapped token may be deployed in networks between various digital accounts.

Various embodiments of these features will now be discussed with respect to the corresponding figures.

### System Overview and Function

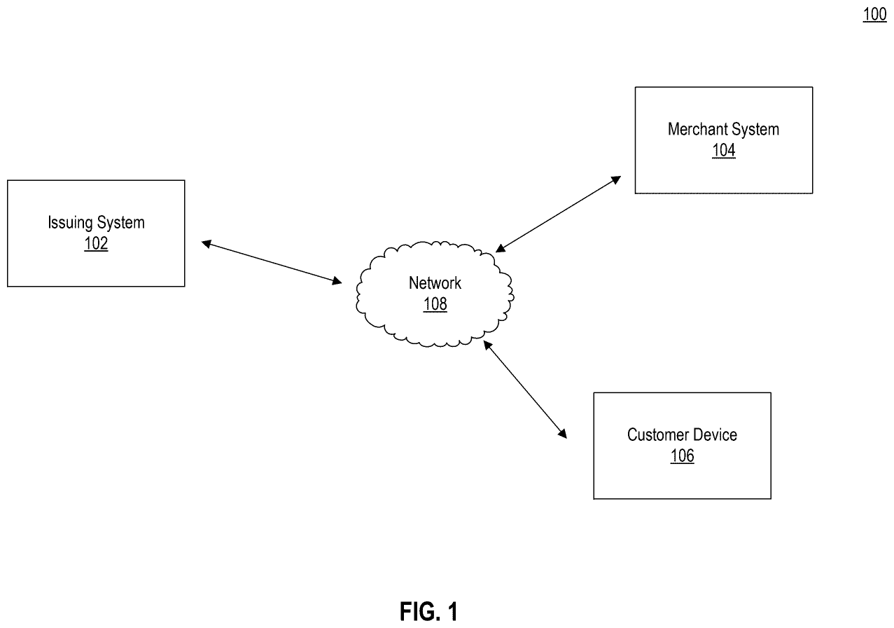

FIG. 1 is a block diagram of an environment 100 for an issuing system 102, in accordance with an embodiment of the present disclosure. Environment 100 may include issuing system 102, a merchant system 104, a customer device 106, and a network 108.

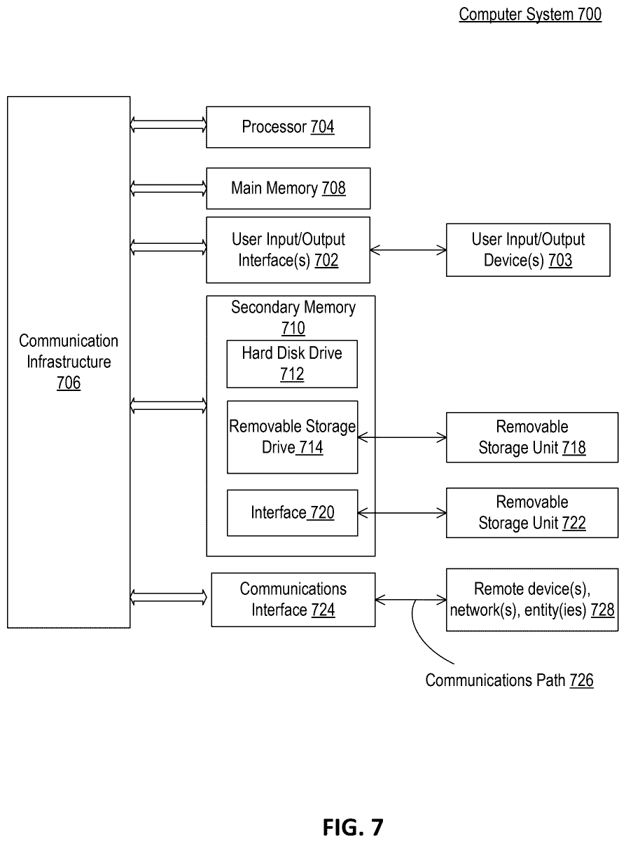

Issuing system 102 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 108. In some aspects, issuing system 102 may be implemented using computer system 700 described with reference to FIG. 7. In some aspects, issuing system 102 may be connected to a blockchain based platform.

Issuing system 102 may provide a cluster computing platform or a cloud computing platform to generate a specially formatted token representing a line of credit, where the formatted token enables utilization as part of transactions between customer device 106 and merchant system 104.

In some aspects, issuing system 102 may correspond to a financial institution (e.g., a bank, a payment card service company, or the like). The financial institution may allow a user to have or manipulate an account. The account may be a checking account, a savings account, a line of credit account, or other type of account. A user of the financial institution can have a plurality of the same or different accounts at the financial institution. In some aspects, the account may correspond to a payment card that has an associated line of credit. Issuing system 102 may issue an account based token with a balance of the line of credit synced in real time. In some embodiments, synchronization between the token and the balance of the line of credit requires a novel formatting of the token such that it is wrapped with rules and other conditions provided by a smart contract. The account based token may be deployed in online transactions similar to a payment card (e.g., a credit card) but can be used for transactions involving digital currencies or DeFi. The formatting of the token with the smart contract provides improvements over conventional payment card payments. One improvement is that the associated line of credit may correspond to a preset borrowing limit offered by the financial institution. This can allow the token to represent a maximum value of the funds available across multiple accounts associated with digital and non-digital assets. For example, the digital token may provide access to funds associated with the line of credit using a conventional payment card or the token as long as the funds do not exceed the line of credit. These transactions may occur and/or be settled in real-time. In some aspects, issuing system may maintain a balance of the line of credit in a first currency (e.g., a fiat currency).

Issuing system 102 may update the token by synchronizing the balance of the line of credit based on received transaction data associated with a transaction. As described further below the transaction may refer to a transaction at merchant system 104. The transaction may also refer to a purchase at an online merchant, to a check payment, to an electronic check payment, an electronic bill payment, a wire transfer, an automated teller machine (ATM) withdrawal, or any other transaction that may be processed using the token that represents the line of credit or the payment card. In addition, the transaction may refer to a payment towards the account. For example, issuing system 102 may detect a payment that involves the balance of the line of credit and may synchronize the balance of the line of credit in real time to enable transactions between digital accounts. For example, the line of credit associated with a physical payment card and the line of credit represented by the token are updated in real-time to reflect the payment towards the account.

In some aspects, the account may represent one or more accounts associated with the line of credit. A first account may be associated with a fiat currency. A second account may be associated a digital asset such as a digital currency. A digital currency is a form of money that exists only in electronic form and is not backed by any physical commodity or legal tender. Digital currencies may be created, stored, transferred, and exchanged using cryptography, peer-to-peer networks, and/or software protocols. Some examples of digital currencies are cryptocurrencies, such as Bitcoin and Ethereum, and a central bank digital currency (CBDC), which operate on decentralized and distributed ledgers, and stablecoins, which are pegged to other assets or currencies to reduce volatility. In some aspects, issuing system 102 may connect to an exchange system such that the value among the one or more accounts is synchronized in real-time.

The CBDC is a type of digital currency that is issued and regulated by a central bank as a legal tender and a liability of the central bank. A CBDC may be designed to have similar features and functions as cash, such as accessibility, anonymity, and finality, or to have additional capabilities, such as programmability, traceability, and interoperability. A CBDC may be implemented using different technologies and architectures, such as token-based or account-based, centralized or decentralized, wholesale or retail, and online or offline. Some examples of CBDC projects are the digital yuan in China, the e-krona in Sweden, and the sand dollar in the Bahamas.

In some aspects, the token is a private issued token by the financial institution. The token is available for payment at merchant system 104. The formatting of the token with rules and conditions of a smart contract allow it to correspond to a traditional credit card but for use on decentralized platforms. Merchant system 104 may redeem the token with issuing system 102 for a fiat currency or a digital currency.

Issuing system 102 may transmit the generated token to customer device 106. The token may be stored in a digital wallet of customer device 106 as described further below. Issuing system 102 may access customer device 106 via an API command or call. As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API®, a standard library such as C++, a JAVA API, and the like.

In addition to generating the token, issuing system 102 may format the token with a token wrapper that includes a smart contract. The smart contract may implement one or more rules and conditions (e.g., rewards, incentives, benefits) associated with the account and/or transactions in the blockchain based platform. The one or more rules may include fraud rules, AML rules and conditions may include reward, insurance, and associated benefits and incentives. For example, for a purchase, a discount rate and a transaction fee can be collected by the issuing system 102. Such discount rate and/or transaction fee can be a flat fee or a percentage of the value of the transaction. The smart contract may refer to a pre-written logic (computer code) that may be stored on a distributed storage (e.g., a block chain). In some aspects, the smart contract may be written in Solidity for the Ethereum virtual machine or any other smart contract supporting network.

Issuing system 102 may receive external data associated with the one or more rules (e.g., from an oracle, from merchant system 104, from a government entity). Issuing system 102 may release the token when certain conditions are met. Releasing the token may refer to the ability of merchant system 104 to redeem the token with issuing system 102.

Merchant system 104 may be as system configured to facilitate in-person and/or online transactions. Merchant system 104 may be a computer system such as computer system 700 described with reference to FIG. 7. Merchant system 104 may include input output (I/O) devices, one or more processors, and a memory such as computer readable media. In some aspects, merchant system 104 may include one or more POS terminals. Merchant system 104 may be associated with a merchant. Merchant system 104 may determine a transaction value (e.g., total value of the merchandise or service provided) and acquire a token that represents the transaction value from a digital wallet of customer device 106. The token represents a portion of the line of credit that corresponds to the transaction value.

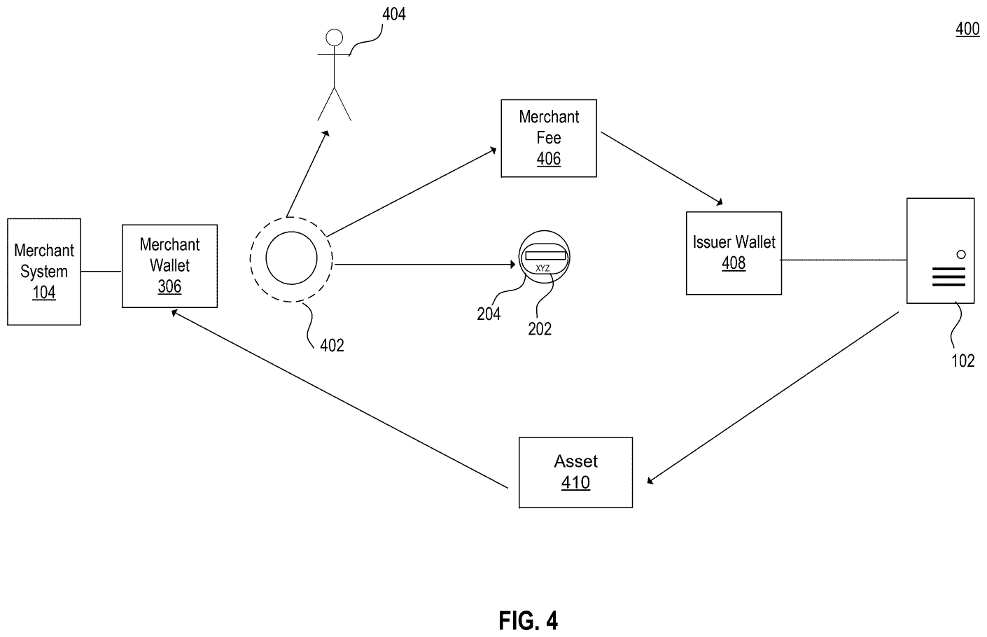

After acquiring the token, merchant system 104 may perform one or more actions to unlock the token (i.e., to release the token from the wrapper) as further described in relation to FIG. 4.

As described herein, the customer may interact with issuing system 102 via customer device 106. Customer device 106 may be a computer system such as computer system 700 described with reference to FIG. 7. For example, customer device 106 may be any variety of electronic devices, such as a mobile device (e.g., smartphone, tablet, pager, personal digital assistant (PDA)), a computer (e.g., a laptop computer, a desktop computer, a server), and/or a wearable device (e.g., a smartwatch). Customer device 106 may include one or more processors and/or memory. Customer device 106 may interact with issuing system 102 to register with the financial institution, transmit a request for a line of credit, or to submit a payment towards the line of credit.

Customer device 106 may be configured to download and/or install a software application associated with a digital wallet or a digital wallet service. The digital wallet service may be used to settle a transaction between customer device 106 and merchant system 104. The digital wallet may correspond to a blockchain wallet, asset account, financial account, central bank digital currency (CBDC) wallet, government and/or state issued digital wallet, private wallet, business wallet, and/or other digital accounts capable of settling transactions. In some aspects, the digital wallet is a third generation of the world wide web (WEB3) wallet. The WEB3 digital wallet may store the token that represents the line of credit and may interface with WEB3 and with other applications such as a decentralized application running on a blockchain network.

Issuing system 102, merchant system 104, and customer device 106 may communicate via network 108. Network 108 may be a telecommunications network, such as a wired or wireless network. Network 108 can span and represent a variety of networks and network topologies. For example, network 108 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 108. Cable, Ethernet, digital subscriber line (DSL), fiber optic lines, fiber to the home (FTTH), and plain old telephone service (POTS) are examples of wired communication that may be included in network 108. Further, network 108 can traverse a number of topologies and distances. For example, network 108 can include a direct connection, personal area network (PAN), local area network (LAN), metropolitan area network (MAN), wide area network (WAN), or a combination thereof.

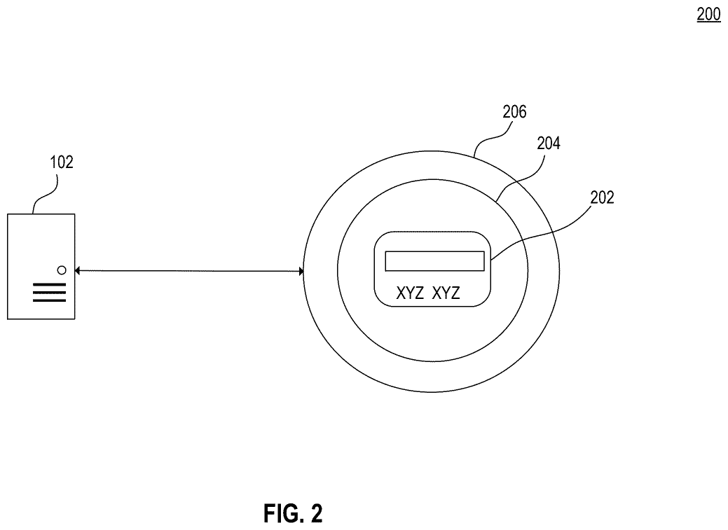

FIG. 2 is a schematic that illustrates a token generation flow 200, in accordance with an embodiment of the present disclosure. As discussed above, issuing system 102 may generate a token 204 that represents a balance of a line of credit 202. Token 204 may be a private issued token by issuing system 102. The balance of line of credit 202 is synced in real time by issuing system 102. Token 204 may be used for payment at merchant system 104. Token 204 may be wrapped using a token wrapper 206. Wrapping token 204 with token wrapper 206 provides the advantage of improving security and regulatory compliance rules for the transaction in addition to building commercial and customer value.

Token wrapper 206 may include a smart contract that implement one or more rules. The smart contract may be used to implement a merchant fee. The merchant fee may represent a fee payable to the financial institution before unlocking the fund represented by the token. In some aspects, the merchant fee may be equivalent to a merchant discount rate (MDR) in traditional finance (TradFi). The merchant fee may be paid by merchant system 104 to issuing system 102 using CBCD, stablecoin, or fiat. The smart contract may also be used to implement one or more rules associated with rewards and incentives. In some aspects, a merchant may offer points or cashback to customer. The smart contract may be used to ensure that the one or more rules are fulfilled before the merchant can redeem the token.

In some aspects, the smart contract may interact with other smart contracts or an oracle. The oracle can be an entity that provides a data feed to the smart contract. The oracle can verify an event (e.g., a merchandise or gift delivery) and submits the information to issuing system 102 or to the smart contract. Based on the information, issuing system 102 and/or the smart contract may update the status of one or more conditions and rules to fulfilled.

In some aspects, the smart contract may implement one or more rules associated with benefits associated with the customer accounts. The smart contract may trigger an insurance benefit associated with a transaction. In some aspects, the smart contract may generate or transfer a non-fungible token (NFT) to a digital wallet associated with the customer after the transaction. The NFT may have a value for a determined number of future transactions. In some aspects, the NFT may be part of a blockchain (e.g., Ethereum blockchain).

In some aspects, the smart contract may implement one or more artificial intelligence (AI) models for fraud control. Using the one or more AI models, the smart contract may validate a payment. For example, the one or more artificial intelligence models may detect a fraudulent transaction by detecting an outlier transaction.

In some aspects, the smart contract may include one or more AI models to implement anti-money laundering (AML) rules and checks. In some aspects, the smart contract may implement due diligence processes of the financial entity such as “know your customer” (KYC) requirements. The AML rules may be based on jurisdictions. For example for transactions involving entities in the United States, the one or more rules implemented by the smart contract may adhere to the AML rules in the United States.

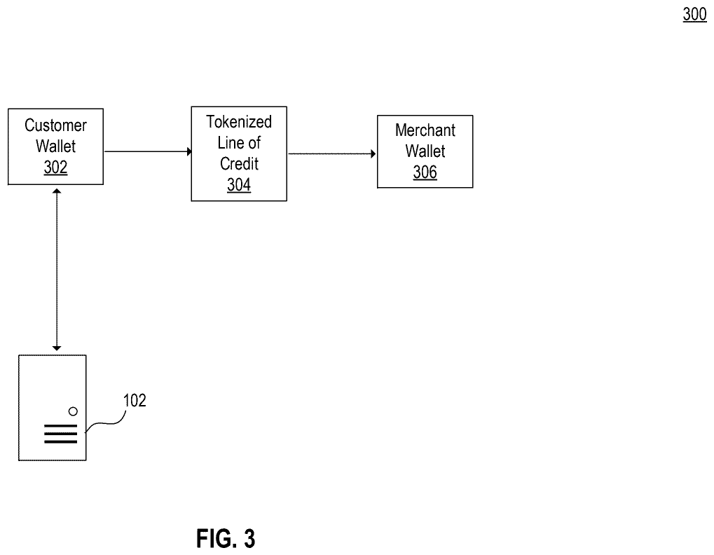

FIG. 3 is a schematic that illustrates a transaction flow 300, in accordance with an embodiment of the present disclosure. A first user may use customer device 106 to complete a transaction with a second user (e.g., a merchant). The second user may be associated with merchant system 104. The description herein can apply to any merchant system (e.g., point of sale system) in a physical retail shop or ecommerce online shopping system. In some aspects, the first user may pay for items purchased using the token that represents the line of credit. In some aspects, the token may be stored in a customer wallet 302. Customer wallet 302 may be associated with customer device 106. A merchant wallet 306 may be associated with merchant system 104.

In some aspects, a fraction of the line of credit is transmitted to merchant wallet 306 from customer wallet 302. The fraction of the line of credit may be equal to the value of the transaction. In some aspects, a token 304 that represents the fraction of the line of credit is generated and transmitted to merchant wallet 306. With the fungible nature of payment token, a fraction of a customer token is generated for the value of the transaction.

The token 304 is transferred from customer wallet 302 to merchant wallet 306. Token 304 may be transferred in a blockchain network. In some aspects, one or more tokens may be stored in merchant wallet 306. Token 304 may be stored in digital merchant wallet 306.

Upon initiating the payment to merchant system 104, issuing system 102 may update a value of token 204 in real time. In addition, the line of credit is synced in real time across other accounts. For example, the available line of credit is updated in traditional finance (TradFi).

The following example illustrates an embodiment of the present disclosure. The customer may use token 204 that represents the available line of credit with merchant system 104 for a purchase of items with a value of $100. The available line of credit may be $500. The value of $100 is transferred to merchant wallet 306. The value of token 204 is updated with a deduction of $100. In addition, the line of credit in synchronized in TradFi (e.g., also updated to $400). The merchant receives $100 added to a merchant token balance. In some aspects, a token that represents the $100 is added to merchant wallet 306.

In some aspects, token 304 may be formatted with wrapper 206. Wrapper 206 is changed to a merchant held wrapper. As discussed previously herein, the wrapper 206 may include one or more smart contracts configured to implement one or more rules associated with the transaction. The merchant may unlock the wrapper for redemption of token by meeting criteria such as payment of a merchant fee as discussed previously herein. After the one or more rules have been fulfilled, the merchant can redeem token 304 for CBDC, stablecoin, or fiat with issuing system 102, as further described in relation to FIG. 4.

FIG. 4 is a schematic that illustrates a token redemption flow 400, in accordance with an embodiment of the present disclosure. A merchant associated with merchant system 104 may receive a smart contract wrapped token from a customer 404. The merchant may fulfill one or more conditions to unlock smart contract wrapped token 402 (i.e., release the token so it can be redeemed for currency with issuing system 102). For example, the merchant may transfer rewards and incentives to customer 404 and a merchant fee 406 to an issuer wallet 408 associated with issuing system 102. In one example, the merchant had a 5% cash back offer with the merchant transaction. Once the customer performs a transaction with the merchant system. The smart contract wrapped token recognizes that the 5% cash back requirement. Issuing system 102 or via the oracle may monitor a transfer of funds between the merchant and the customer (e.g., from merchant wallet 306 to customer wallet 302). Once the conditions are satisfied (e.g., the cash back requirement have been paid), the smart contract unlocks smart contract wrapped token 402. Then, the token may be redeemed with issuing system 102. Issuing system 102 may transfer an asset 410 (e.g., CBDC, stablecoin, fiat) to merchant wallet 306.

### Methods of Operation

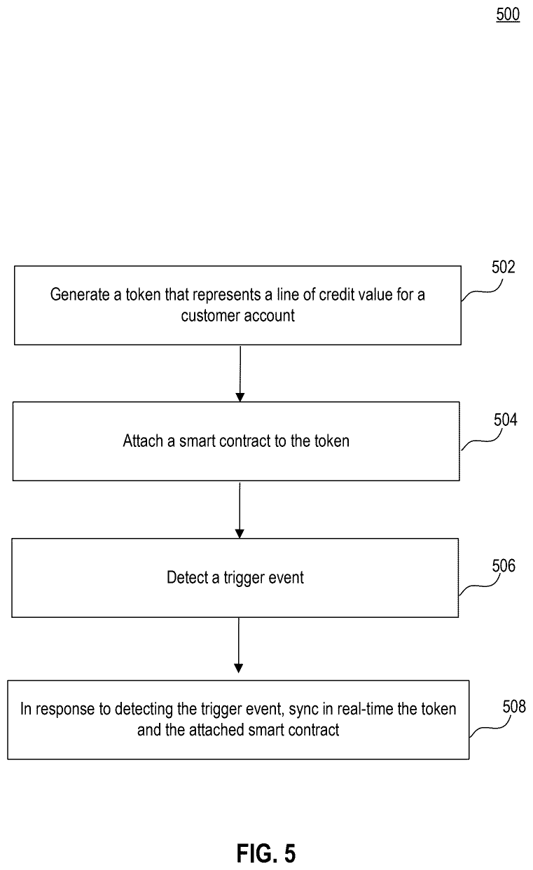

FIG. 5 is an example method 500 for generating a token that represents a line of credit, in accordance with an embodiment of the present disclosure. Method 500 may be performed as a series of steps by a computing unit such as a processor. For example, method 500 may be implemented by issuing system 102 and/or computer system 700 of FIG. 7. Method 500 shall be described with reference to FIG. 1, however, method 500 is not limited to that example embodiment.

In 502, issuer system 102 may generate a token that represents a line of credit value for a customer account.

In 504, issuer system 102 may attach a smart contract to the token to create a token that is formatted to enable payment transactions between different distributed digital accounts. The smart contract is configured to implement one or more rules associated with the customer account when the token is deployed within a payment transaction. The wrapped token that includes the smart contract may be stored in a digital wallet of a customer device. The one or more rules may comprise a payment of a merchant fee, a fulfillment of a reward or incentive, or a fraud validation rule.

In 506, issuer system 102 may detect a trigger event associated with a change in a balance of the line of credit value or the one or more rules. The trigger event may be a transaction at a merchant system or a payment received from a customer towards the line of credit. The transaction may be accomplished using the token or using a traditional payment card. In some aspects, the trigger event may be an update in one or more rules implemented by the smart contract. For example, an incentive may be added to the smart contract (e.g., new spend). In addition, the smart contract may be updated based on changes in regulatory and AML rules.

In 508, in response to detecting the trigger event, issuer system 102 may synchronize in real-time the smart contract wrapped token with the line of credit. For example, the value of the token may be decreased or increased based on the balance of the line of credit.

In some aspects, issuing system 102 and/or the digital wallet may generate another token that represents a portion of the line of credit. The portion of the line of credit is equal to a value of the transaction. In some aspects, the trigger event may correspond to the generating of the another token. Issuing system 102 may update the line of credit value associated with the account in real time. Issuing system 102 may update another line of credit value associated with another customer account. For example, the another customer account may be associated with a non-digital asset (e.g., a credit card for fiat currency). The customer account and the another customer account are associated with the same customer.

It is to be appreciated that not all steps may be needed to perform the disclosure provided herein. Further, some of the steps may be performed simultaneously, or in a different order than shown in FIG. 5, as will be understood be a person of ordinary skill in the art.

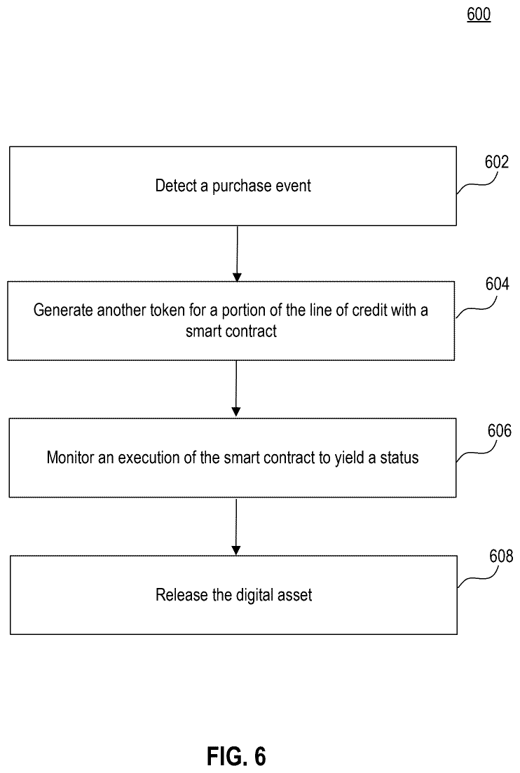

FIG. 6 is an example method 600 for performing a transaction using the tokenized line of credit, in accordance with an embodiment of the present disclosure. Method 600 may be performed as a series of steps by a computing unit such as a processor. For example, method 600 may be implemented by issuing system 102 and/or computer system 700 of FIG. 7. Method 600 shall be described with reference to FIG. 1, however, method 600 is not limited to that example embodiment.

In 602, issuing system 102 may detect a purchase event at merchant system 104.

In 604, issuing system 102 or digital wallet may generate another token for a portion of the line of a credit. The value of the line of credit may be equal to the value of the transaction. In some aspects, the token may be wrapped with the smart contract. The token with the attached smart contract is transferred from a first digital wallet associated with customer device 106 to a second digital wallet associated with merchant system 104.

In 606, issuing system 102 may monitor the execution of the smart contract to yield a status. In some aspects, issuing system 102 may monitor a transfer of an asset between merchant system 104 and issuing system 102. In some aspects, the status may be based on a data feed from an oracle. For example, issuing system 102 may analyze the data feed to determine whether the one or more conditions of the smart contract are met. In some aspects, the smart contract is run on the distributed ledger.

In 608, issuing system 102 may release the digital asset associated with the token based on the status. For example, in response to the status indicating that one or more conditions of the one or more rules are fulfilled, the token is unlocked from the smart contract. The token may be redeemed for general currency (e.g., a digital asset such as CBDC or stablecoin or non digital asset such as fiat. Merchant system 104 may request the redemption of the token from issuing system 102.

### Components of the System

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof. For example, the method steps of FIGS. 5 and 6 may be implemented via computer system 700.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method comprising:
generating, using at least one processor of an issuer system, a token for a customer account, wherein the token is indicative of a line of credit value that represents available funds across multiple accounts associated with digital and non-digital assets;
attaching a smart contract to the token to create a wrapped token, wherein the smart contract is configured to implement one or more rules associated with the customer account, wherein the wrapped token is deployed in a digital transaction;
detecting a trigger event associated with a change in a balance of the line of credit value or the one or more rules; and
in response to detecting the trigger event, syncing in real-time the wrapped token with the balance of the line of credit.

2. The method of claim 1, wherein the trigger event is a transaction at a merchant system, and wherein the method further comprises:
storing the wrapped token in a first digital wallet of a customer device;
generating another token that represents a portion of the line of credit, wherein the smart contract is attached to the another token, and wherein the portion of the line of credit is equal to a value of the transaction; and
transferring the another token with the attached smart contract from the first digital wallet to a second digital wallet associated with the merchant system.

3. The method of claim 2, further comprising:
monitoring an execution of the smart contract to yield a status;
upon the status indicating that one or more conditions of the one or more rules are fulfilled, unlocking by the issuer system the another token from the smart contract; and
redeeming the another token with a digital asset.

4. The method of claim 3, wherein monitoring the execution of the smart contract comprises:
monitoring a transfer of an asset between the merchant system and the issuer system associated with the customer account.

5. The method of claim 2, further comprising:
in response to generating the another token, updating the line of credit value associated with the customer account in real time; and
updating another line of credit value associated with another customer account, wherein the another customer account is associated with a non-digital asset and wherein the customer account and the another customer account are associated with a same customer.

6. The method of claim 3, wherein the digital asset is cryptocurrency.

7. The method of claim 1, wherein the one or more rules comprises a payment of a merchant fee, a fulfillment of a reward or incentive, or a fraud validation rule.

8. A system, comprising:
a memory; and
at least one processor coupled to the memory and configured to:
generate a token for a customer account, wherein the token is indicative of a line of credit value that represents available funds across multiple accounts associated with digital and non-digital assets;
attach a smart contract to the token to generate a wrapped token, wherein the smart contract is configured to implement one or more rules to enable real-time synchronization between the token and a balance of the line of credit value associated with the customer account, wherein the wrapped token is deployed in a digital transaction;
detect a trigger event associated with a change in the balance of the line of credit value or the one or more rules; and
in response to detecting the trigger event, sync in real-time the wrapped token with the balance of the line of credit.

9. The system of claim 8, wherein the trigger event is a transaction at a merchant system, and wherein the at least one processor is further configured to:
store the token and the attached smart contract in a first digital wallet of a customer device; and
generate another token that represents a portion of the line of credit, wherein the smart contract is attached to the another token, and wherein the portion of the line of credit is equal to a value of the transaction; and
transfer the another token with the attached smart contract from the first digital wallet to a second digital wallet associated with the merchant system.

10. The system of claim 9, wherein the at least one processor is further configured to:
monitor an execution of the smart contract to yield a status;
upon the status indicating that one or more conditions of the one or more rules are fulfilled, unlock by an issuer system the another token from the smart contract; and
redeem the another token with a digital asset.

11. The system of claim 10, wherein to monitor the execution of the smart contract the at least one processor is further configured to:
monitor a transfer of an asset between the merchant system and an issuer system associated with the customer account.

12. The system of claim 9, wherein the at least one processor is further configured to:
in response to generating the another token, update the line of credit value associated with the customer account in real time; and
update another line of credit value associated with another customer account, wherein the another customer account is associated with a non-digital asset and wherein the customer account and the another account are associated with a same customer.

13. The system of claim 10, wherein the digital asset is cryptocurrency.

14. The system of claim 8, wherein the one or more rules comprises a payment of a merchant fee, a fulfillment of a reward or incentive, or a fraud validation rule.

15. A non-transitory computer-readable device having instructions stored thereon that, when executed by at least one computing device, cause the at least one computing device to perform operations comprising:
generating a token for a customer account, wherein the token is indicative of a line of credit value that represents available funds across multiple accounts associated with digital and non-digital assets;
attaching a smart contract to the token to generate a wrapped token, wherein the smart contract is configured to implement one or more rules associated with the customer account, wherein the wrapped token is deployed in a digital transaction;
detecting a trigger event associated with a change in a balance of the line of credit value or the one or more rules; and
in response to detecting the trigger event, syncing in real-time the wrapped token with the balance of the line of credit value.

16. The non-transitory computer-readable device of claim 15, wherein the trigger event is a transaction at a merchant system and wherein the operations further comprises:
storing the token and the attached smart contract in a first digital wallet of a customer device;
generating another token that represents a portion of the line of credit, wherein the smart contract is attached to the another token, and wherein the portion of the line of credit is equal to a value of the transaction; and
transferring the another token with the attached smart contract from the first digital wallet to a second digital wallet associated with the merchant system.

17. The non-transitory computer-readable device of claim 16, the operations further comprising:
monitoring an execution of the smart contract to yield a status;
upon the status indicating that one or more conditions of the one or more rules are fulfilled, unlocking by an issuer system the another token from the smart contract; and
redeeming the another token with a digital asset.

18. The non-transitory computer-readable device of claim 17, the operations further comprising:
in response to generating the another token, updating the line of credit value associated with the customer account in real time; and
updating another line of credit value associated with another customer account, wherein the another customer account is associated with a non-digital asset and wherein the customer account and the another customer account are associated with a same customer.

19. The non-transitory computer-readable device of claim 17, wherein the digital asset is cryptocurrency.

20. The non-transitory computer-readable device of claim 15, wherein the one or more rules comprises a payment of a merchant fee, a fulfillment of a reward or incentive, or a fraud validation rule.
